(19) United States
(12) Patent Application Publication
(10) Pub. No.: US 2025/0065480 A1
(43) Pub. Date: Feb. 27, 2025

(54) Tongue Break-Off Tool And Tongue Break-Off Method

(71) Applicant: SANYU SEIKI CORPORATION, Tokyo (JP)

(72) Inventor: Tamaki Goto, Tokyo (JP)

(21) Appl. No.: 18/720,879

(22) PCT Filed: Oct. 28, 2022
(86) PCT No.: PCT/JP2022/040545

§ 371 Date: Jun. 17, 2024

(30) Foreign Application Priority Data
Dec. 15, 2021 (JP) 2021-202971

(51) Int. Cl. B25B 27/14

(52) U.S. Cl. CPC B25B 27/143

(57) ABSTRACT

A tongue break-off tool includes an insertion member including a hook that hooks a tongue of a tongued insert inserted into a tap hole. A movement member moves the insertion member in a diagonal direction diagonally intersecting with an extending direction of the tap hole from a deep side of the tap hole to a near side of the tap hole such that the tongue is broken off from the tongued insert. A defining member including a receiving hole through which the insertion member is passed in the extending direction such that the insertion member is accommodated in the receiving hole. A to-be-gripped section makes contact with the movement member. The defining member is gripped such that a grip section of the movement member is fitted in the to-be-gripped section, and the insertion member is rotatable relative to the movement member around the extending direction as a rotation axis.

### TECHNICAL FIELD

Embodiments of the present invention relate to a tongue break-off tool and a tongue break-off method.

### BACKGROUND

Generally, in a case where a strong internal thread is required, e.g., a case where durability is required for an internal thread or a case where strong fastening is required, an insert called a coil insert, a threaded insert, or the like is used, for example. An insert is formed such that a wire made of stainless steel or the like is wound in a coil form and is screwed and inserted (embedded) into a tap hole (a threaded hole) of a workpiece made of resin, aluminum alloy, or the like by an insert insertion tool.

A tongue bent in the diameter direction of the coil is formed in an end portion of the insert. In a case where such a tongued insert is inserted into a tap hole, a user uses the insert insertion tool to pinch the tongue by a distal end portion of the insert insertion tool or hook the distal end portion of the insert insertion tool on the tongue, so that the user rotates the insert via the tongue and screws the insert into the tap hole.

The tongue is used at the time when the insert is inserted into the tap hole as such and is not necessary after the insert is inserted. Therefore, when the tongue remains, the tongue may obstruct entry of an external thread at the time of fastening of the external thread. In view of this, to break off the tongue after the insert is inserted, a notch for the tongue breaking-off is formed around the base of the tongue.

After the insert is inserted into the tap hole, the user breaks off the tongue such that the user puts a pin such as a steel rod on the tongue and hits the head of the pin with a hammer (a breaking off operation). However, because the tongue thus broken off from the insert remains inside the tap hole, the user collects the tongue from the tap hole by use of a tool such as tweezers (a collecting operation).

To break off the tongue as such, it is necessary to perform both the breaking off operation and the collecting operation, and replacement of tools is required during the operations. Accordingly, the operations are interrupted and working efficiency decreases. Further, in the breaking off operation of the tongue, a large force is applied to the tongue in the insertion direction of the insert, so that so-called pitch deviation in which a thread of a workpiece deviates from a thread of the insert may occur.

When the pitch deviation occurs, it is difficult to screw the external thread. As a result, it is necessary to pull the insert out of the workpiece once and then insert a new insert into the workpiece again. In view of this, to solve these inconveniences, the applicants of this application have developed a tongue break-off tool described in JP Patent Publication No. 6879581 B.

### SUMMARY

The tongue break-off tool described in JP Patent Publication No. 6879581 B can dramatically eliminate pitch deviation of an insert in a conventional breaking off operation using a steel rod or the like and collect a broken off tongue without leaving it in a tap hole, thereby making it possible to markedly improve working efficiency. On the other hand, some inconveniences were found occasionally in the following point.

That is, as described above, the tongued insert is inserted into a tap hole with the tongue being pinched by the insert insertion tool, but which direction the tongue faces in the tap hole varies depending on each tap hole. In addition, it is difficult to manage the orientation of the tongue after insertion.

Further, even in a case where the tongue break-off tool is used, it is necessary to rotate the tongue break-off tool to correspond to the orientation of the tongue at the time when the distal end of the tongue break-off tool hooks the tongue to break off the tongue.

This is because the orientation of a distal end portion of the tongue break-off tool to hook the tongue is fixed. Further, tongues in respective tap holes face various directions. Therefore, in a state where a tongue is hooked on the distal end portion, a grip of pliers to be held by an operator to break off the tongue might be placed at a position distanced from the operator.

As a result, it is necessary for the operator to change the orientation of his or her body to hold the grip each time. Alternatively, to place the grip in an orientation where the operator can easily hold the grip, the orientation of a workpiece itself having a tap hole in which an insert is inserted should be changed. This increases the number of steps necessary for break off, which may decrease working efficiency.

The present invention is achieved in order to solve the problem, and an object of the present invention is to provide a tongue break-off tool and a tongue break-off method in each of which a movement member is always placed at the hand of an operator at the time of break off of a tongue of an insert inserted in a tap hole even when the tongue faces any direction, so that working efficiency can be improved.

A tongue break-off tool according to an embodiment of the present invention includes an insertion member including a hook hooks a tongue of a tongued insert inserted into a tap hole, a movement member moves the insertion member in a diagonal direction diagonally intersecting with an extending direction of the tap hole from a deep side of the tap hole to a near side of the tap hole such that the tongue is broken off from the tongued insert, and a defining member including a receiving hole through which the insertion member is passed in the extending direction such that the insertion member is accommodated in the receiving hole, and a to-be-gripped section with which the movement member makes contact. The defining member is gripped such that a defining member grip section of the movement member is fitted in the to-be-gripped section, and the insertion member is rotatable relative to the movement member around the extending direction as a rotation axis.

Further, the insertion member constituting the tongue break-off tool includes a main body, a coupler coupled with one end portion of the main body and coupled with the movement member, and a hook member provided in the other end portion of the main body, which other end portion is an end portion opposite to the one end portion of the main body, and the hook member includes the hook.

Further, the hook member is formed to be detachable from the main body. Further, the hook member includes a fitting section on one end side of the hook member, the fitting section being couplable with the main body, and the hook is provided on the other end side of the hook member such that the tongue is hooked on the hook.

The hook has a hook surface on which the tongue is hooked. The hook is formed to hook the tongue in a state where a longitudinal direction of the hook surface is perpendicular to an extending direction of the tongue. The hook hooks the tongue when the insertion member is inserted into the tap hole and then rotated.

The tongue break-off tool further includes a driving section that rotates the hook.

The movement member includes an insertion member holding section rotatably making contact with the insertion member in addition to the defining member grip section, and the movement member moves the hook member such that the tongue is hooked on the hook and pulled up in the diagonal direction to be broken off from the tongued insert.

The tongue break-off tool further includes a holding member that holds the tongue broken off from the tongued insert and is hooked on the hook.

A tongue break-off method according to an embodiment of the present invention is a tongue break-off method using a tongue break-off tool including an insertion member including a hook hooks a tongue of a tongued insert inserted into a tap hole, a movement member moves the insertion member, and a defining member including a receiving hole through which the insertion member is passed in an extending direction of the tap hole such that the insertion member is accommodated in the receiving hole and a to-be-gripped section with which the movement member makes contact, the defining member being gripped such that a defining member grip section of the movement member is fitted in the to-be-gripped section, and the insertion member being rotatable relative to the movement member around the extending direction as a rotation axis. The tongue break-off method includes hooking, on the hook, the tongue of the tongued insert inserted in the tap hole by rotating a coupler or a main body of the insertion member, and moving, by the movement member, the insertion member in a diagonal direction diagonally intersecting with an extending direction of the tap hole from a deep side of the tap hole to a near side of the tap hole such that the tongue is broken off from the tongued insert.

With the tongue break-off tool or the tongue break-off method according to embodiments of the present invention, the movement member is placed at the hand of an operator at the time of break off of the tongue of an insert inserted in a tap hole even when the tongue faces any direction, thereby making it possible to improve working efficiency.

### BRIEF DESCRIPTION OF THE DRAWINGS

FIG. 1 is a perspective view illustrating a whole tongue break-off tool according to an embodiment of the present invention.

FIG. 2 is a left side view illustrating the whole tongue break-off tool according to an embodiment of the present invention.

FIG. 3 is an exploded perspective view illustrating the configuration of an insertion member and a defining member according to an embodiment of the present invention.

FIG. 4 is a perspective view illustrating the configuration of a movement member of the tongue break-off tool according to an embodiment of the present invention.

### DETAILED DESCRIPTION OF EMBODIMENTS

The following describes embodiments of the present invention in detail with reference to the drawings. Note that, in the embodiments, directions of up, down, right, and left are based on the drawings.

Further, the embodiments described below deals with an example of the present invention. Further, various changes or improvements can be added, and embodiments with the changes or improvements can be also included in the present invention. The embodiments and their modifications are included in the scope of the invention and are also included in the invention described in claims and in its equivalent range.

### Basic Configuration

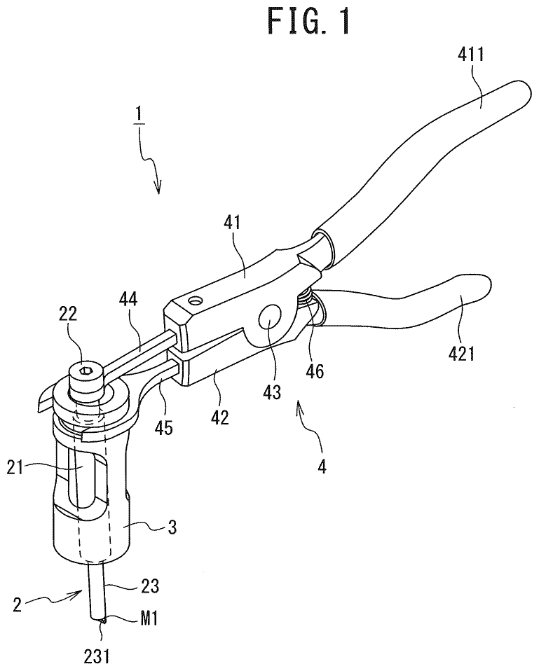

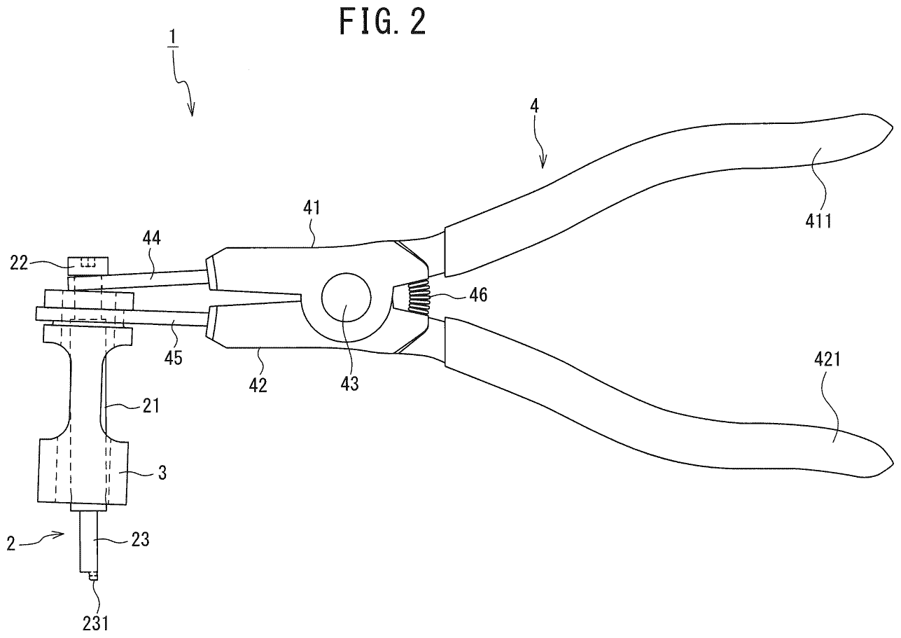

First, FIG. 1 is a perspective view illustrating a whole tongue break-off tool 1 according to an embodiment of the present invention. Further, FIG. 2 is a left side view illustrating the whole tongue break-off tool 1 according to an embodiment of the present invention.

As illustrated in FIGS. 1 and 2, the tongue break-off tool 1 according to an embodiment of the present invention includes an insertion member 2, a defining member 3, and a movement member 4. The tongue break-off tool 1 is used to break off and collect a tongue from a tongued insert (hereinafter referred to as an “insert” appropriately) inserted (embedded) into a tap hole of a workpiece (not illustrated).

As illustrated in FIGS. 1 and 2, the tongue break-off tool 1 is configured such that the insertion member 2 and the defining member 3 are connected respectively to an insertion member holding section 44 and a defining member grip section 45 provided to project from a distal end portion of the movement member 4. Further, the insertion member 2 is placed to pass through the inside of the defining member 3.

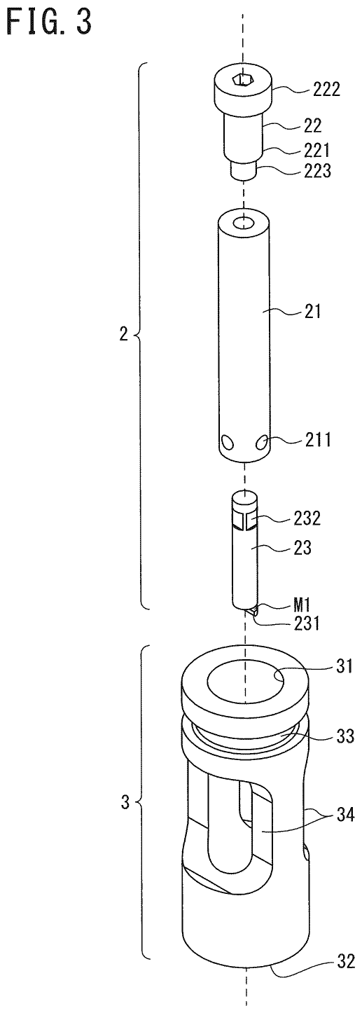

Here, FIG. 3 is an exploded perspective view illustrating the configuration of the insertion member 2 and the defining member 3 according to an embodiment of the present invention. Among the members illustrated in FIG. 3, three upper members are components of the insertion member 2, and a lower member is the defining member 3.

The insertion member 2 is inserted into the insert inserted in the tap hole of the workpiece and contacts the tongue at the time when the tongue is broken off. The insertion member 2 illustrated in FIG. 3 is constituted by three members, which are a main body 21, a coupler 22, and a hook member 23.

The main body 21 is formed in a columnar shape and is a portion serving as the body of the insertion member 2. The coupler 22 is fitted in one end portion of the main body 21, which end portion is on the upper side. As illustrated in FIG. 1 or 2, the coupler 22 is coupled with the insertion member holding section 44 of the movement member 4 to constitute part of the tongue break-off tool 1.

The coupler 22 is constituted by a contact section 221 coupled with the insertion member holding section 44, a rotation section 222 formed in an upper end portion of the contact section 221, and an insertion section 223 formed in a lower end portion of the contact section 221. Due to the shape of the insertion member holding section 44 described later, the contact section 221 is fitted in the insertion member holding section 44 with the outer peripheral surface of the contact section 221 in contact with the insertion member holding section 44, so that the whole insertion member 2 is rotatable.

The rotation section 222 is used to rotate the insertion member 2 such that the hook member 23 (described later) hooks the tongue as a break off target after the insertion member 2 is inserted into the tap hole.

That is, as described above, the orientation of the tongue of the insert screwed into the tap hole varies. Accordingly, such a case is conceivable that, when the insertion member 2 is just inserted into the tap hole, the hook member 23 cannot hook a tongue. In view of this, the insertion member 2 is rotated by use of the rotation section 222 so that the insertion member 2 inserted in the tap hole can surely hook the tongue on the hook member 23.

Note that the diameter of the rotation section 222 is formed to be larger than the diameter of the contact section 221. This is to cause the whole insertion member 2 to be held by the insertion member holding section 44 due to a surface on the rotation section 222 side of the contact section 221 being brought into contact with the insertion member holding section 44 at the time when the contact section 221 is fitted to a through-hole 441 of the insertion member holding section 44 (described later).

Further, the insertion section 223 is used to couple the coupler 22 with the main body 21. That is, the insertion section 223 is coupled with an upper end portion of the main body 21. Note that the insertion section 223 may be fitted to the main body 21, provided that the coupler 22 and the main body 21 can be coupled with each other in such a manner that the coupler 22 and the main body 21 can rotate together. Alternatively, an external thread may be formed on the insertion section 223, and an internal thread may be formed in an upper end portion of the main body 21 so that the insertion section 223 is coupled with the main body 21.

In a case where the insertion member 2 is rotated, an operator pinches and rotates the rotation section 222 with fingers, for example. Alternatively, other than such a method of manually rotating the insertion member 2, a driving section (not illustrated) may be provided in the coupler 22, for example, such that the coupler 22 is rotated by the driving section. Herein, the rotation section 222 is rotated, but the insertion member 2 may be rotated by rotating the main body 21, for example.

Note that the rotation section 222 in this embodiment of the present invention is also formed in a columnar shape to correspond to the main body 21. However, in consideration of easy operations at the time when the operator rotates the insertion member 2, a shape such as a square columnar shape or a polygonal shape, for example, may be employed instead of the columnar shape.

The hook member 23 is formed in a columnar shape, and a hook (a hook section) 231 is formed in a lower end portion of the hook member 23. The hook 231 is formed in an L-shape to hook the tongue of the insert inserted in the tap hole. As illustrated in FIGS. 1, 2, the hook member 23 is connected to part of the movement member 4 and is configured to be movable upward by the movement member 4 (details will be described later).

Here, the insertion member 2 is inserted into the tap hole from the hook 231 side and moves in the depths of the tap hole. At this time, even when the hook 231 abuts with the tongue, the tongue is not broken off. In a case where the tongue is broken off, the operator pinches the rotation section 222 to rotate the insertion member 2 such that the tongue is pinched between a hook surface M1 of the hook 231 formed in an L-shape and a surface facing the hook surface M1 in contact therewith, for example. When the insertion member 2 is moved upward by the movement member 4 with the tongue being pinched by the hook 231 as such, the tongue is broken off.

A fitting section 232 is provided in an upper end portion of the hook member 23. The fitting section 232 can be coupled with a fixing section 211 provided in a lower end portion of the main body 21, so that the hook member 23 is fixed to the lower end portion of the main body 21. Various configurations can be employed as the configuration of the fitting section 232, provided that the fitting section 232 is fixed so as not to fall when the fitting section 232 is coupled with the main body 21, and the fitting section 232 can rotate together when the insertion member 2 rotates.

The defining member 3 is formed in a cylindrical shape (a sleeve shape) and has a receiving hole 31 formed as a through-hole in the longitudinal direction of the receiving hole 31. The receiving hole 31 is formed to have a size that allows the hook member 23 (the insertion member 2) to be moved and accommodated therein.

Further, a workpiece contact section 32 configured to make contact with a workpiece is provided in a lower end portion of the defining member 3. The workpiece contact section 32 directly contacts the workpiece to apply a force toward the workpiece at the time when the tongue of the insert embedded in the tap hole is broken off with the tongue break-off tool 1, so that the tongue is easily broken off.

Note that a guard made of a resin material may be put on the workpiece contact section 32, for example. The guard is formed in a torus-like shape and functions as a buffer material that moderates an impact when the defining member 3 abuts with the surface of the workpiece.

The defining member 3 abuts with the surface of the workpiece via the workpiece contact section 32 at the time when the tongue is broken off from the insert inserted in the tap hole. Hereby, the defining member 3 defines a separation distance between the tap hole and the movement member 4, that is, a separation distance (for example, a vertical separation distance) between the surface of the workpiece and the movement member 4 (details will be described later).

A to-be-gripped section 33 is formed to be entirely recessed on the outer periphery of an upper portion of the defining member 3. Because the to-be-gripped section 33 is formed in such a shape, the defining member grip section 45 (described later) is fitted in the to-be-gripped section 33, so that the defining member 3 is gripped by the movement member 4.

Further, a hollow section 34 is formed in a central portion of the defining member 3. The hollow section 34 is formed such that the surface of the defining member 3 is cut from its outer periphery toward the receiving hole 31 to hollow part of the surface in a direction perpendicular to the penetration direction of the insertion member 2.

Because the hollow section 34 is formed in the defining member 3 as such, the insertion member 2 passed through the receiving hole 31 can be rotated via the hollow section 34. That is, at the time when the hook 231 hooks the tongue inside the tap hole, the insertion member 2 is rotated. When the insertion member 2 is rotated, the rotation section 222 can be used as described above.

However, depending on an operator who performs an operation of breaking off the tongue by use of the tongue break-off tool 1, such a case is conceivable that it is difficult for the operator to rotate the insertion member 2 by use of the rotation section 222. In view of this, the hollow section 34 is provided in the defining member 3 so that the insertion member 2 can be rotated without the use of the rotation section 222.

For example, when the operator puts a hand on the defining member 3 such that the hollow section 34 is sandwiched between the thumb and the forefinger, the thumb and the forefinger contact the main body 21 of the insertion member 2. Accordingly, the operator can rotate the insertion member 2 by use of the thumb and the forefinger.

Note that, at the time of forming the hollow section 34, it is also conceivable that a region to be hollowed is expanded downward in a direction where the insertion member 2 is passed through the receiving hole 31 in addition to the region illustrated in FIG. 3, for example.

However, in a case where the region for the hollow section 34 is formed to be too close to the workpiece contact section 32, it is conceivable that a broken off tongue falls outside from the hollow section 34 at the time when the tongue is pulled up by the insertion member 2. If the tongue thus broken off falls in the course of pulling up the tongue, such an inconvenience that the tongue falls in another tap hole might occur.

In view of this, in the defining member 3 the region for the hollow section 34 is set minimally to such an extent that the operator can touch the insertion member 2 through the hollow section 34 to rotate the insertion member 2.

Note that, in the defining member 3 according to this embodiment of the present invention, the hollow section 34 is formed as such, but the defining member 3 may be formed in a cylindrical shape without forming the hollow section 34 in the first place.

As illustrated in FIG. 1, 2, or 4, the movement member 4 is pliers in this embodiment of the present invention. At the time when the tongue is broken off from the insert inserted in the tap hole, the movement member 4 moves, by use of the pliers, the hook member 23 in a direction diagonally intersecting with the extending direction of the tap hole from the deep side to the near side (from the lower side to the upper side) of the tap hole, that is, in a diagonal direction (details will be described later).

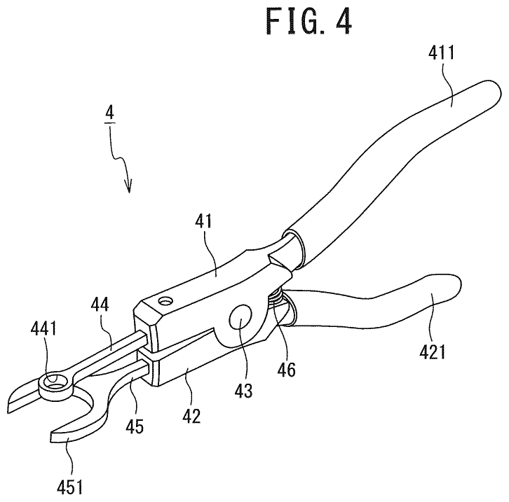

FIG. 4 is a perspective view illustrating the configuration of the movement member 4 of the tongue break-off tool 1 according to an embodiment of the present invention. The movement member 4 (pliers) includes a first stay 41 and a second stay 42. The first stay 41 and the second stay 42 are coupled with each other via a pivot 43 (a rotating shaft) such that their end portions come close to and separate from each other, and thus, the first stay 41 and the second stay 42 form a pincers structure in which end portions can open and close freely.

The insertion member holding section 44 is coupled with one end portion of the first stay 41. The other end side of the insertion member holding section 44 which other side is opposite to one end side coupled with the first stay 41 has a through-hole 441 having a circular shape. The contact section 221 in the coupler 22 of the insertion member 2 is placed to be passed through the through-hole 441.

As described above, the coupler 22 is formed such that the diameter of the rotation section 222 is larger than the diameter of the contact section 221. Therefore, in a case where the coupler 22 is coupled with the main body 21 and the hook member 23 to be formed as one insertion member 2, the insertion member 2 is held by the movement member 4 via the insertion member holding section 44.

Note that the diameter of the through-hole 441 is formed to be larger than the diameter of the contact section 221. Therefore, the insertion member 2 is rotatable with the insertion member 2 being held by the insertion member holding section 44.

The defining member grip section 45 is coupled with one end portion of the second stay 42. A fork 451 having a projecting shape with separated end portions to hold the defining member 3 is formed on the other end side of the defining member grip section 45 which other end side is opposite to one end side connected to the second stay 42. As illustrated in FIGS. 1 and 2, the defining member 3 is gripped by the movement member 4 when the fork 451 abuts with the to-be-gripped section 33.

Note that the defining member 3 is gripped by the defining member grip section 45 contacting the to-be-gripped section 33, but the defining member 3 and the defining member grip section 45 may be configured to be rotatable. Alternatively, the defining member 3 may be non-rotatable when the defining member 3 is gripped by the defining member grip section 45.

The other end portion of the first stay 41 and the other end portion of the second stay 42 are formed to serve as grip sections 411, 421 to be held by a user. The first stay 41 and the second stay 42 are biased by a biasing member 46 in a direction (a closed direction) where the insertion member holding section 44 and the defining member grip section 45 as one end portions of the first stay 41 and the second stay 42 come close to each other. As the biasing member 46, a spring such as a coil spring is used, for example.

### Tongue Break Off Operation

Next will be described a tongue break off operation using the tongue break-off tool 1 described above.

The insert is formed such that a wire (for example, metal such as stainless steel) having a diamond-shaped section is wound in a coil form. The outer peripheral surface of the insert functions as an outside thread, and the inner peripheral surface of the insert functions as an inside thread. A tongue bent in the diameter direction of the coil is formed in one end portion of the insert. A notch for tongue breaking off is formed around the base of the tongue in the insert.

The notch is formed in the insert such that a small piece of the tongue broken off from the insert has a “V” shape. The notch is formed such that a rotation angle around the axis of the coil is within a range from 10 degrees to 90 degrees (the extending direction of the tongue is 0 degrees), for example, in the circumference direction of the coil connected to the tongue from the base of the tongue. When the insert is inserted into the tap hole by an insert insertion tool, the tongue is placed on the deep side of the tap hole.

In the tongue break off operation of breaking off the tongue, first, the operator holds the grip sections 411, 421, which are the other end portion of the movement member (pliers) 4, and inserts the insertion member 2, that is, the hook member 23 into the tap hole from the upper side of the tap hole. Note that, in this state, the grip sections 411, 421 are not gripped by the operator. Further, at this time, the defining member 3 does not make contact with the workpiece.

While the hook member 23 thus inserted is gradually lowered with the hook 231 coming down first, the hook 231 contacts the tongue or does not contact the tongue such that the hook 231 reaches a position where the tongue is placed.

In a case where the hook 231 thus inserted does not contact the tongue, the hook 231 is placed at a position where the hook surface M1 can hook the tongue although it is uncertain whether the hook surface M1 of the hook 231 faces a direction in which the tongue can be hooked on the hook 231.

Subsequently, the insertion member 2 is rotated by the operator such that the tongue is hooked with the tongue being pinched between the hook surface M1 and its facing surface. As described above, because the orientation of the tongue is uncertain at the point when the insertion member 2 is inserted into the tap hole, it is uncertain whether the tongue can be hooked on the hook surface M1. In view of this, the insertion member 2 is rotated so that the hook 231 contacts the tongue so that the tongue is hooked on the hook surface M1.

Note that, at the time of rotating the insertion member 2, the insertion member 2 is also rotatable when the coupler 22 receives a driving force from a driving section, for example, as described above, other than a method in which the operator manually rotates the insertion member 2.

Further, as described above, as the method in which the operator rotates the insertion member 2, there is also a method in which fingers are brought into contact with the main body 21 of the insertion member 2 through the hollow section 34 of the defining member 3 to rotate the insertion member 2, other than the method of rotating the rotation section 222 of the insertion member 2.

When the insertion member 2 rotates, the hook surface M1 of the hook 231 contacts the tongue such that the tongue is pinched between the hook surface M1 and its facing surface. Whether the tongue is pinched by the hook surface M1 can be grasped based on a state where the insertion member 2 cannot rotate further. When the operator feels such a resistance, the operator recognizes that the tongue is pinched by the hook surface M1 so that the operator can grip the grip sections 411, 421 of the movement member 4.

In this state, the grip sections 411, 421 of the movement member 4 are gripped by the operator. In response to this, the first stay 41 and the second stay 42 of the movement member 4 move to a direction (an open direction) where the insertion member holding section 44 and the defining member grip section 45 provided in respective one end portions of the first stay 41 and the second stay 42 are separated from each other.

At this time, the insertion member holding section 44 provided in one end portion of the first stay 41 contacts the contact section 221 of the coupler 22 of the insertion member 2 in the through-hole 441, so that the insertion member 2 itself also moves upward along with upward movement of the insertion member holding section 44 of the first stay 41.

In the meantime, when the first stay 41 and the second stay 42 move in the direction where they are separated from each other, the workpiece contact section 32 of the defining member 3 provided in one end portion of the second stay 42 contacts the surface of the workpiece. More specifically, the receiving hole 31 of the workpiece contact section 32 contacts the periphery of the tap hole in which the insert having a tongue as a breaking off target is inserted.

When the workpiece contact section 32 of the defining member 3 contacts the surface of the workpiece, a vertical separation distance between the surface of the workpiece and the movement member 4 is fixed. Hereby, the defining member grip section 45 provided in one end portion of the second stay 42 is restricted from moving further downward. Accordingly, the defining member grip section 45 does not move downward, and a downward force is applied to the workpiece.

In the meantime, the insertion member holding section 44 provided in one end portion of the first stay 41 is kept moving upward. That is, the insertion member holding section 44 keeps raising the insertion member 2 upward. Due to the movement of the insertion member 2, the tongue pinched by the hook 231 also moves upward.

When the hook member 23 rises, the hook 231 of the hook member 23, hooking the tongue, is raised. As described above, the hook 231 hooks the tongue in a state where the longitudinal direction of the hook surface M1 is perpendicular to the extending direction of the tongue.

Then, the hook member 23 with the hook 231 hooking the tongue rises in a diagonal direction inclined only by a predetermined acute angle (for example, a predetermined angle within a range from seven degrees to eight degrees) relative to the extending direction of the tap hole. When the grip sections 411, 421 (see FIGS. 1 and 2) of the movement member 4 are closed, the upward movement of the insertion member holding section 44 in one end portion of the first stay 41 stops, so that the movement of the hook member 23 also stops.

In the middle of rising of the hook member 23, the tongue is broken off from the insert, and the tongue thus broken off is held by the hook 231. Then, the tongue break-off tool 1 is raised upward from the workpiece by the operator, and the hook member 23 is taken out of the tap hole. The tongue is broken off from the hook 231 by the operator.

In the tongue break off operation, the operator holds the grip sections 411, 421 of the movement member 4, inserts the insertion member 2 into the insert inside the tap hole from the hook 231 side, and rotates the insertion member 2 so that the hook 231 pinches the tongue. When the hook 231 pinches the tongue, the operator grips the grip sections 411, 421 of the movement member 4, so that the insertion member 2 moves upward to break off the tongue from the insert.

Hereby, the tongue thus broken off is collected by the tongue break-off tool 1. Accordingly, an operation of collecting the broken off tongue from the tap hole by use of a tool such as tweezers is unnecessary unlike the conventional technology, thereby making it possible to improve working efficiency. Further, the tongue can be pinched by the hook 231 by rotating the insertion member 2 even when the tongue of the insert inside the tap hole faces any direction, so that the tongue can be surely broken off.

Further, the hook 231 is caught on the tongue and is then pulled up in the diagonal direction diagonally intersecting with the extending direction of the tap hole from the deep side to the near side of the tap hole. Accordingly, in comparison with a case where the hook 231 hooks the tongue and is pulled up in parallel to the extending direction of the tap hole from the deep side to the near side of the tap hole, the tongue can be surely broken off.

Note that it is confirmed experimentally in a large number of tongues that a tongue that cannot be broken off by raising the hook 231 in parallel to the extending direction of the tap hole can be broken off by raising the hook 231 in the diagonal direction.

The inclination angle of the diagonal direction is a predetermined acute angle within a range of angles from seven degrees to eight degrees relative to the extending direction of the tap hole, for example. When the hook 231 is caught on the tongue, a force is applied to the tongue in the direction of the predetermined angle.

The predetermined angle is set based on the diameter, the height (a length parallel to the extending direction of the tap hole), or the like of the insert. However, to facilitate the break off of the tongue, for example, it is preferable that the predetermined angle be 20 degrees or less. Further, in order to downsize the defining member 3 in addition to facilitating the break off of the tongue, it is preferable that the predetermined angle be 10 degrees or less.

Here, when the operator operates the movement member 4 in a state where the hook 231 does not hook the tongue, the hook member 23 moves along the circle around the pivot 43, that is, a curved line, and the hook 231 also moves along the curved line. In a state where the hook member 23 is not inserted into the tap hole, the movement member 4 moves the hook member 23 such that the hook 231 rotates around the pivot 43 as a rotation axis, the pivot 43 intersecting with (for example, perpendicular to) a plane parallel to the extending direction of the tap hole and the extending direction of the tongue.

Further, because the insertion member 2 and the defining member 3 are formed to be detachable from the movement member 4, the insertion member 2 and the defining member 3 can be detached. On this account, when several types of defining members or several types of insertion members are prepared, the insertion member 2 or the defining member 3 can be replaced with another type of defining member or another type of insertion member in response to the diameter, the height, or the like of the insert, for example.

As described above, with the tongue break-off tool 1 according to this embodiment of the present invention, the hook member 23 including the hook 231 hooking the tongue of the insert inserted in the tap hole is moved by the movement member 4 in the diagonal direction diagonally intersecting with the extending direction of the tap hole from the deep side to the near side of the tap hole, so that the tongue is broken off from the insert inserted in the tap hole.

Note that, as described above, the hook 231 of the hook member 23 holds the tongue thus pinched and broken off. However, instead of this form, the hook 231 may be provided with a holding member, for example.

That is, the holding member is placed near a portion of the hook 231 with which portion the tongue abuts, e.g., near the hook surface M1 of the hook 231. As the holding member, a magnet (as an example, a permanent magnet) that adheres to the tongue is used, for example. Further, instead of the holding member, the hook member 23 itself or the hook 231 itself may be magnetized to adhere to and hold the broken off tongue, for example.

When such a holding member is provided or the hook member 23 or the like is magnetized, the tongue broken off from the insert is held by the holding member or the like. Hereby, the tongue thus broken off can be collected by the tongue break-off tool 1. Accordingly, a collecting operation of collecting the broken off tongue from the tap hole by use of a tool such as tweezers is unnecessary, unlike the conventional technology, thereby making it possible to improve working efficiency. Further, replacement of tools can be also made unnecessary, so that the operation is not interrupted due to replacement of tools, thereby making it possible to improve working efficiency.

Further, the hook 231 may have any shape, provided that the hook 231 can pinch and break off a tongue.

Further, the insertion member 2 described above is constituted by three members, i.e., the main body 21, the coupler 22, and the hook member 23, as illustrated in FIG. 3. However, instead of this a configuration, the insertion member 2 may be configured such that the main body 21 and the hook member 23 are integrated as one member, for example. Further, alternatively, the whole insertion member 2 may be configured as one member.

Note that the technology described herein may employ the following configurations.

(1) A tongue break-off tool includes: an insertion member including a hook hooks a tongue of a tongued insert inserted into a tap hole; a movement member moves the insertion member in a diagonal direction diagonally intersecting with an extending direction of the tap hole from a deep side of the tap hole to a near side of the tap hole such that the tongue is broken off from the tongued insert; and a defining member including a receiving hole through which the insertion member is passed in the extending direction such that the insertion member is accommodated in the receiving hole, and a to-be-gripped section with which the movement member makes contact. The defining member is gripped such that a defining member grip section of the movement member is fitted in the to-be-gripped section, and the insertion member is rotatable relative to the movement member around the extending direction as a rotation axis.

(2) In the tongue break-off tool described in (1), the insertion member includes: a main body; a coupler coupled with one end portion of the main body and coupled with the movement member; and a hook member provided in the other end portion of the main body which other end portion is an end portion opposite to the one end portion of the main body, the hook member including the hook.

(3) In the tongue break-off tool described in (2), the hook member is formed to be detachable from the main body.

(4) In the tongue break-off tool described in (3), the hook member includes a fitting section on one end side of the hook member, the fitting section being couplable with the main body; and the hook is provided on the other end side of the hook member such that the tongue is hooked on the hook.

(5) In the tongue break-off tool described in any of (1) to (4), the hook has a hook surface on which the tongue is hooked, and the hook is formed to hook the tongue in a state where a longitudinal direction of the hook surface is perpendicular to an extending direction of the tongue.

(6) In the tongue break-off tool described in any of (1) to (5), the hook hooks the tongue when the insertion member is inserted into the tap hole and then rotated.

(7) The tongue break-off tool described in any of (1) to (6) further includes a driving section rotates the hook.

(8) In the tongue break-off tool described in any of (1) to (7), the movement member includes an insertion member holding section rotatably making contact with the insertion member in addition to the defining member grip section.

(9) In the tongue break-off tool described in any of (1) to (8), the movement member moves the hook member such that the tongue is hooked on the hook and pulled up in the diagonal direction to be broken off from the tongued insert.

(10) The tongue break-off tool described in any of (1) to (9) further includes a holding member holds the tongue broken off from the tongued insert and hooked on the hook.

(11) A tongue break-off method uses a tongue break-off tool including: an insertion member including a hook hooks a tongue of a tongued insert inserted into a tap hole; a movement member moves the insertion member; and a defining member including a receiving hole through which the insertion member is passed in an extending direction of the tap hole such that the insertion member is accommodated in the receiving hole, and a to-be-gripped section with which the movement member makes contact, the defining member being gripped such that a defining member grip section of the movement member is fitted in the to-be-gripped section, the insertion member being rotatable relative to the movement member around the extending direction as a rotation axis. The tongue break-off method includes: hooking, on the hook, the tongue of the tongued insert inserted in the tap hole by rotating a coupler or a main body of the insertion member; and moving, by the movement member, the insertion member in a diagonal direction diagonally intersecting with an extending direction of the tap hole from a deep side of the tap hole to a near side of the tap hole such that the tongue is broken off from the tongued insert.

The following is a list of reference signs used in this specification and in the drawing figures.
1 tongue break-off tool
2 insertion member
21 main body
211 fixing section
22 coupler
221 contact section
222 rotation section
223 insertion section
23 hook member
231 hook
232 fitting section
3 defining member
31 receiving hole
32 workpiece contact section
33 to-be-gripped section
34 notch
4 movement member (pliers)
41 first stay
411 grip section
42 second stay
421 grip section
43 pivot
44 insertion member holding section
45 defining member grip section
441 through-hole
451 fork
M1 hook surface

1. A tongue break-off tool comprising:
an insertion member including a hook hooks a tongue of a tongued insert inserted into a tap hole;
a movement member moves the insertion member in a diagonal direction diagonally intersecting with an extending direction of the tap hole from a deep side of the tap hole to a near side of the tap hole such that the tongue is broken off from the tongued insert; and
a defining member including a receiving hole through which the insertion member is passed in the extending direction such that the insertion member is accommodated in the receiving hole, and a to-be-gripped section with which the movement member makes contact, wherein:
the defining member is gripped such that a defining member grip section of the movement member is fitted in the to-be-gripped section; and
the insertion member is rotatable relative to the movement member around the extending direction as a rotation axis.

2. The tongue break-off tool according to claim 1, wherein the insertion member includes:
a main body;
a coupler coupled with one end portion of the main body and coupled with the movement member; and
a hook member provided in the other end portion of the main body which other end portion is an end portion opposite to the one end portion of the main body, the hook member including the hook.

3. The tongue break-off tool according to claim 2, wherein the hook member is formed to be detachable from the main body.

4. The tongue break-off tool according to claim 3, wherein:
the hook member includes a fitting section on one end side of the hook member, the fitting section being couplable with the main body; and
the hook is provided on the other end side of the hook member such that the tongue is hooked on the hook.

5. The tongue break-off tool according to claim 1, wherein:
the hook has a hook surface on which the tongue is hooked; and
the hook is formed to hook the tongue in a state where a longitudinal direction of the hook surface is perpendicular to an extending direction of the tongue.

6. The tongue break-off tool according to claim 1, wherein the hook hooks the tongue when the insertion member is inserted into the tap hole and then rotated.

7. The tongue break-off tool according to claim 1, further comprising a driving section rotates the hook.

8. The tongue break-off tool according to claim 1, wherein the movement member includes an insertion member holding section rotatably making contact with the insertion member in addition to the defining member grip section.

9. The tongue break-off tool according to claim 1, wherein the movement member moves the hook member such that the tongue is hooked on the hook and pulled up in the diagonal direction to be broken off from the tongued insert.

10. The tongue break-off tool according to claim 9, further comprising a holding member holds the tongue broken off from the tongued insert and hooked on the hook.

11. A tongue break-off method using a tongue break-off tool including
an insertion member including a hook hooks a tongue of a tongued insert inserted into a tap hole,
a movement member moves the insertion member, and
a defining member including a receiving hole through which the insertion member is passed in an extending direction of the tap hole such that the insertion member is accommodated in the receiving hole, and a to-be-gripped section with which the movement member makes contact,
the defining member being gripped such that a defining member grip section of the movement member is fitted in the to-be-gripped section,
the insertion member being rotatable relative to the movement member around the extending direction as a rotation axis,
the tongue break-off method comprising:
hooking, on the hook, the tongue of the tongued insert inserted in the tap hole by rotating a coupler or a main body of the insertion member; and
moving, by the movement member, the insertion member in a diagonal direction diagonally intersecting with an extending direction of the tap hole from a deep side of the tap hole to a near side of the tap hole such that the tongue is broken off from the tongued insert.
